(19) United States
(12) Patent Application Publication
(10) Pub. No.: US 2011/0115888 A1
(43) Pub. Date: May 19, 2011

(54) BROADCAST RECEIVING APPARATUS AND CONTROL METHOD THEREFOR

(75) Inventors: Yuichi Matsumoto, Fujisawa-shi (JP); Shuntaro Aratani, Machida-shi (JP)

(73) Assignee: CANON KABUSHIKI KAISHA, Tokyo (JP)

(21) Appl. No.: 12/939,715

(22) Filed: Nov. 4, 2010

(30) Foreign Application Priority Data
Nov. 13, 2009 (JP) 2009-259417
Jul. 21, 2010 (JP) 2010-164009

(51) Int. Cl. H04N 13/04

(52) U.S. Cl. 348/51; 348/E13.026

(57) ABSTRACT

A broadcast receiving apparatus is provided with an image identifying unit that identifies the type of a received broadcast image and a simulcast identifying unit that identifies a simulcast of a received broadcast. A glasses control and communication unit communicates with the viewing glasses, and identifies whether a user is wearing glasses based on the detection signal of a state-of-wear detecting unit 115. In the case in which a channel selection operation is carried out while glasses are being worn and it has been identified by the image identifying unit that a program image is a two dimensional image, a channel carrying out a three dimensional image broadcast of a program having a content that is identical to that on a two dimensional image simulcast is automatically selected, and a three dimensional image is displayed. At this time, the program information display unit displays broadcast program information for the channel that has been designated for selection along with the image.

### BACKGROUND OF THE INVENTION

1. Field of the Invention

The present invention relates to a broadcast receiving apparatus that can receive three dimensional image broadcasts and two-dimensional image broadcasts.

2. Description of the Related Art

Over the past several years, accompanying the progress in digital technology, a production environment for three dimensional broadcast programs that can be viewed stereoscopically has been under development, and three dimensional image broadcasts have started. The three dimensional image broadcasts currently carried out use a side-by-side format. In this method, a film having polarizing characteristics is adhered to a display screen, and the images for the right eye and the left eye are provided in an interlaced display. By the viewer viewing this displayed video through polarizing glasses, stereoscopic viewing by the user becomes possible because the left eye display lines can be seen by the left eye and the right eye display lines can be seen by the right eye. In addition, in the future, in order to display more finely detailed stereoscopic images, it is contemplated that broadcasting will be carried out by using a frame sequential format. In a broadcast receiving apparatus that can receive three dimensional image broadcasts in a frame sequential format, the left eye image and the right eye image are alternately displayed, and the user visualizes the image by using LCD shutter glasses. Specifically, by using the shutter glasses, the viewer can perceive a stereoscopic image because shutter control is carried out such that the left eye image is seen only by the left eye and the right eye image is seen only by the right eye.

In this manner, in a three dimensional image broadcast receiving apparatus that uses a glasses format, there is a problem in that when a three dimensional image is displayed while a user is not wearing glasses, the image becomes very uncomfortable to view. As a technology for solving this problem, Japanese Patent Laid-Open No. H9-9296 discloses a technology that provides a stereoscopic image prohibiting means, and when a function that prohibits stereoscopic image display is not selected, a stereoscopic image is generated and displayed. In addition, Japanese Patent Laid-Open No. 2000-4453 discloses a technology that identifies whether a user is wearing glasses, and in the case in which the user is wearing glasses, a three dimensional image is generated and displayed.

In the future, it is contemplated that receiving devices that are compatible with three dimensional image broadcasts and receiving devices that are not compatible will be used together, and thus, naturally, an environment in which three dimensional image broadcast programs and two dimensional image broadcast programs coexist will continue. In this broadcast format as well, in addition to configurations in which only three dimensional image broadcast programs for receiving devices that are compatible with three dimensional image broadcasting are broadcast, a configuration, referred to a simulcasting is contemplated in which two programs, one of three dimensional images and one of two dimensional images, are broadcast simultaneously on two channels for programs having identical content. In addition to simulcasting, a case in which the stream of a three dimensional image broadcast program and a stream of a two dimensional image broadcast program are broadcast by being multiplexed on a single channel can also be considered. In any case, the viewers must carry out the channel selection after considering whether or not they are wearing glasses and whether or not a broadcast program corresponds to a three dimensional image or a two dimensional image. Thus, the channel selection operation may become extremely complicated. Therefore, in the future, there will be a demand to provide the viewer with a channel selection method that can be applied to a broadcast environment in which three dimensional image broadcast programs and two dimensional image broadcast programs coexist.

Thus the present invention identifies, in a broadcast environment in which three dimensional image broadcasts and two dimensional image broadcasts are mixed, whether or not the user can view a three dimensional image by using glasses. According to the result of this identification, the channel selection and selection of the displayed image is facilitated, and that the same time, the convenience for the user is improved.

### SUMMARY OF THE INVENTION

In order to solve the problems described above, a first apparatus according to the present invention is a broadcast receiving apparatus that receives broadcast signals that broadcast a three dimensional image that can be stereoscopically viewed by using glasses and a two dimensional image that can be viewed without using glasses, provided with a detecting unit configured to detect whether or not the user can view a three dimensional image by using glasses; an image identification unit configured to identify whether an image of a broadcast program of a selected channel is a three dimensional image or a two dimensional image by using identification information that is included in the broadcast signal; and a broadcast identification unit configured to identify whether or not there is a channel in which broadcast programs having content identical to that of a broadcast program of the selected channel and have different dimensions are being broadcast; and a control unit configured to control the selection operation according to the detected results by the detecting unit, the identified results by the image identifying unit, and the identification results by the broadcast identification unit. The control unit carries out control so as to select a three dimensional image broadcast channel in the case in which, while a viewer can view a three dimensional image, it is identified that the image of the broadcast program being broadcast on the selected channel is a two dimensional image and it is identified that there is a three dimensional image broadcast channel broadcasting a three dimensional program having a content that is identical to that of the broadcast program for the two dimensional image, and carries out control so as to select a two dimensional image broadcast channel in the case in which, while a viewer cannot view a three dimensional image, it is identified that the image of a broadcast program being broadcast on a selected channel is a three dimensional image and it is identified that there is a two dimensional image broadcast channel broadcasting a broadcast program of a two dimensional image having a content identical to that of the broadcast program of the three dimensional image.

A second apparatus according to the present invention is a broadcast receiving apparatus that receives a broadcast signal that broadcasts three dimensional image that can be stereoscopically viewed by using glasses and a two dimensional image that can be viewed without using glasses, provided with a detecting unit configured to detect whether or not a user can view a three dimensional image by using glasses; and a selection unit configured to carry out channel selection in sequence in the forward or reverse order of the sequence of channel numbers; an image identification unit configured to identify whether the image of a broadcast program being broadcast by a selected channel is a three dimensional image or a two dimensional image by using identification information included in a signal; and a control unit configured to control the selection operation according to the detected result by the detecting unit and the identified result by the image identifying unit. The control unit carries out control to select channels in sequence by selecting channels that are broadcasting a three dimensional image in the case in which selection is carried out by the selection means while the user can view a three dimensional image, and carries out control to select channels in sequence by selecting channels that are broadcasting a two dimensional image in the case in which selection is carried out by the selection unit when the user cannot view a three dimensional image.

According to the present invention, in an environment in which three dimensional image broadcast programs and two dimensional image broadcast programs are mixed, it is identified whether or not a user can view a three dimensional image by using glasses. According to this identification result, channel selection and selection of the displayed image is facilitated, and the convenience to the user can be improved.

Further features of the present invention will become apparent from the following description of exemplary embodiments (with reference to the attached drawings).

### BRIEF DESCRIPTION OF THE DRAWINGS

FIG. 1 is a block diagram exemplifying a schematic structure of a broadcast receiving apparatus according to an embodiment of the present invention.

FIG. 2 is a drawing that shows a display example of broadcast program information.

FIG. 3 is a drawing that exemplifies the image components types.

FIG. 4 is a flowchart showing an example of the selection processing in order to explain, along with FIG. 5, the first embodiment of the present invention.

FIG. 5A exemplifies the channel numbers, broadcast station names, program names, and types of broadcast images, in a table format

FIG. 5B is a drawing that shows an example of the display of broadcast program information.

FIG. 6 is a flowchart showing an example of the selection processing in order to explain, along with FIG. 7, the second embodiment of the present invention.

FIG. 7A is a drawing that exemplifies a broadcast channel list in a table format.

FIG. 7B is a drawing that exemplifies a broadcast channel list in a table format.

FIG. 8 is a drawing showing an example of the image and audio configuration for a multi-view broadcast for explaining, along with FIG. 9, a third embodiment of the present invention.

FIG. 9 is a flowchart showing an example of the switching process of the display image.

### DESCRIPTION OF THE EMBODIMENTS

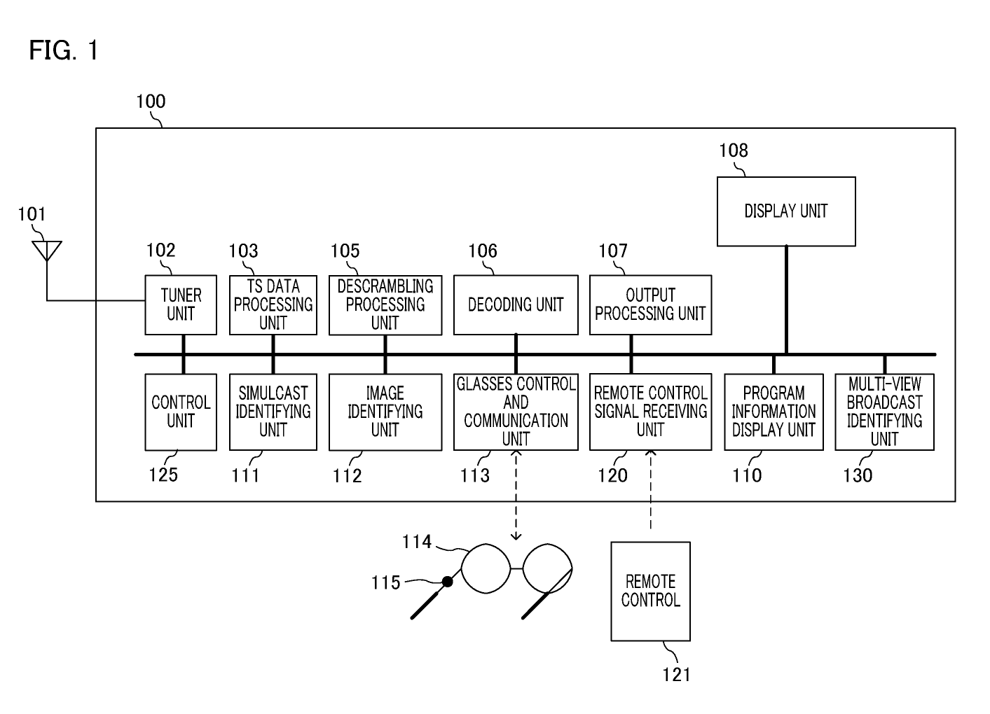

FIG. 1 shows an example of a configuration of a broadcast receiving apparatus according to an embodiment of the present invention, and is a block diagram that shows the principal components of a digital television broadcast receiving apparatus (DTV) that can receive and display three dimensional image broadcasts and two dimensional image broadcasts. Note that a user can view the three dimensional images provided by the apparatus shown in the present example by using dedicated shutter classes, and the user can view two dimensional images without using these glasses.

The broadcast receiving apparatus 100 is provided with a tuner unit 102 that is connected to an antenna 101, a transport stream data processing unit 103 (below, “transport stream” is abbreviated TS), a descrambling processing unit 105, a decode processing unit 106, an output processing unit 107, and a display unit 108.

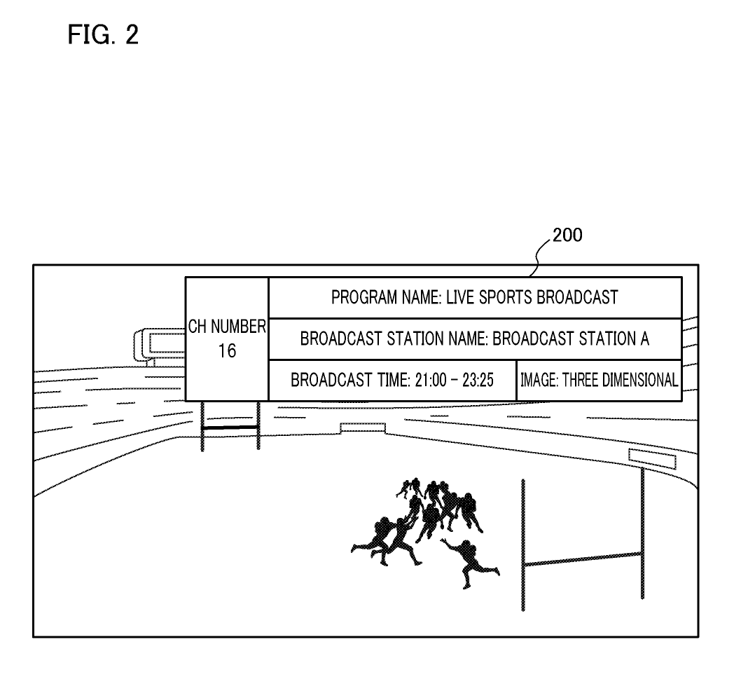

The program information display section 110 carries out display control such that the image of the selected channel is displayed along with broadcast program information related to the broadcast program of the channel that the user has designated for selection. Examples of the broadcast program information that is displayed include the channel numbers, broadcast station names, program names, and the broadcast starting times and broadcast ending times of the programs. In addition, image type information is displayed that indicates that the image is a SD (Standard Definition) image quality or an HD (High Definition) image quality, and a three dimensional image or a two dimensional image. FIG. 2 shows a display example of the broadcast program information, and the user viewing the display of the broadcast program information 200 understands that broadcast station A is broadcasting live sports on channel 16 from 21:00 to 23:25 in a three dimensional image.

The simulcast broadcast identifying unit 111 forms a group identification unit configured to identify whether or not images are broadcast images within the same group, and sends the identification results to a control unit 125 that is described below. The image identifying unit 112 identifies whether or not the image of the received broadcast program is a three dimensional image or a two dimensional image, and sends the identification results to the control unit 125 that is described below.

Note that “simulcast” is an expression denoting a configuration in which programs having identical content are broadcast simultaneously in the same time slot using different broadcast media or channels. Presently, examples of representative configurations of a simulcast that is generally carried out include a configuration in which programs having the same content are broadcast in the same time slot using analog broadcast and digital broadcast and a configuration in which programs having the same content are broadcast in the same time slot using terrestrial digital broadcasting and “one segment” broadcasting (broadcasting for mobile terminals). As explained above, general simulcasting denotes broadcasting programs having the same content. However, in the present invention, “simulcasting” denotes a configuration in which a program consists of a three dimensional image and a program having a content that is identical to that of this program and consists of a two dimensional image are broadcast simultaneously in the same time slot using different broadcast media and channels. Therefore, in a strict sense, this means “simultaneous broadcasts having identical content and different dimensions, that is, a two dimensional image broadcast and a three dimensional image broadcast”, and in order to facilitate understanding of the explanation, in each of the embodiments, please note that this is expressed by the term “simulcast”.

The glasses control and communication unit 113 communicates with the glasses 114 to carry out shutter control thereof, and carries out control such that the left eye image enters the left eye of the user and the right eye image enters the right eye of the user. That is, the three dimensional image in the present embodiment has a frame sequential or a field sequential format, and the left eye image and the right eye image are alternately displayed. The user's operation instruction made by using the remote control 121 is received by the remote control signal receiving unit 120. When the remote control signal receiving unit 120 receives a command code transmitted from the remote control 121 using infrared light, the command code is transferred to the control unit 125.

The control unit 125 is structured by using a CPU (Central Processing Unit) and a memory device such as ROM and RAM and the like, and is responsible for control of the apparatus overall. The control unit 125 and other units are connected so as to enable transmitting to each other and receiving from each other required information through a bus. The control unit 125 controls the channel selection operation and the displayed image switching operation and the like according to the results of detecting whether glasses are being worn and the results of identification by the simulcast identifying unit 111 and the image identifying unit 112, and this will be explained in detail below. In addition, the multi-view broadcast identifying unit 130 will be explained in an embodiment described below.

Next, the basic operation of the broadcast receiving apparatus 100 will be explained.

After a digital broadcast signal that is input via an antenna 101 is converted to a TS by the tuner unit 102, the resulting signal is transferred to the TS data processing unit 103. The TS data processing unit 103 separates the multiplexed TS into an image elementary stream (below, “elementary stream” is abbreviated ES), the audio ES, and the data ES. Furthermore, the TS data processing unit 103 is structured to separate the PSI, SI, PMT, SDT, and EIT and the like, and enable recognizing the image type of the selected channel and a simulcast channel and the like. Note that PSI is the abbreviation for “Program Specific Information”, and SI is the abbreviation for “Service Information”. Furthermore, PMT is the abbreviation for “Program Map Table”, SDT is the abbreviation for “Service Description Table”, and EIT is the abbreviation for “Event Information Table”.

Because scrambling processing is carried out by the ES in a MULTI2 format, a descrambling processing must be carried out. In this case, the TS data processing unit 103 obtains a descramble key from an IC card (not illustrated) and sets the descramble key in the descrambling processing unit 105. The descrambling processing unit 105 carries out descrambling of the ES, and the image ES and the audio ES after the descrambling process are decoded by the decoding processing unit. The image data that has undergone decoding processing is sent to the output processing unit 107, and after the processing that is necessary for image display has been performed, the image is displayed by the display unit 108. The display unit 108 alternately displays the left eye image and the right eye image when carrying out the display of a three dimensional image.

The program information display unit 110 displays broadcast program information related to broadcast programs being displayed by superimposing the image displayed by the display unit 108 as necessary. Generally, such a display is referred to as a “program information banner display”. The program information banner is controlled so as to be displayed for several seconds after the channel is selected. The image identifying unit 112 identifies whether the image of the image ES being processed is a three dimensional image or a two dimensional image, and notifies the control unit 125 about the results of the identification. According to the standards of the Association of Radio Industries and Businesses (ARIB), in a digital broadcast, various types of information related to the image, audio, and programs can be multiplexed in a transmission signal in the form of various types of tables in the PSI and SI data, and transmitted.

In the present invention, (component_type) for each type of component of a component descriptor is used as an identifier for identifying whether the image is a three dimensional image or a two dimensional image. The component descriptor is included in the EIT that maintains the information related to the program, such as the program name, broadcast time, and broadcast explanation and the like. Using the information for the component type, image format information that shows whether the image format is for a three dimensional image or a two dimensional image and information that shows whether there is a simulcast is being carried out is transmitted or distinguished. In addition, information for the broadcast format and the channel related to a simulcasting is transmitted to the apparatus by using link descriptors inserted in the PMT, SDT, and the EIT.

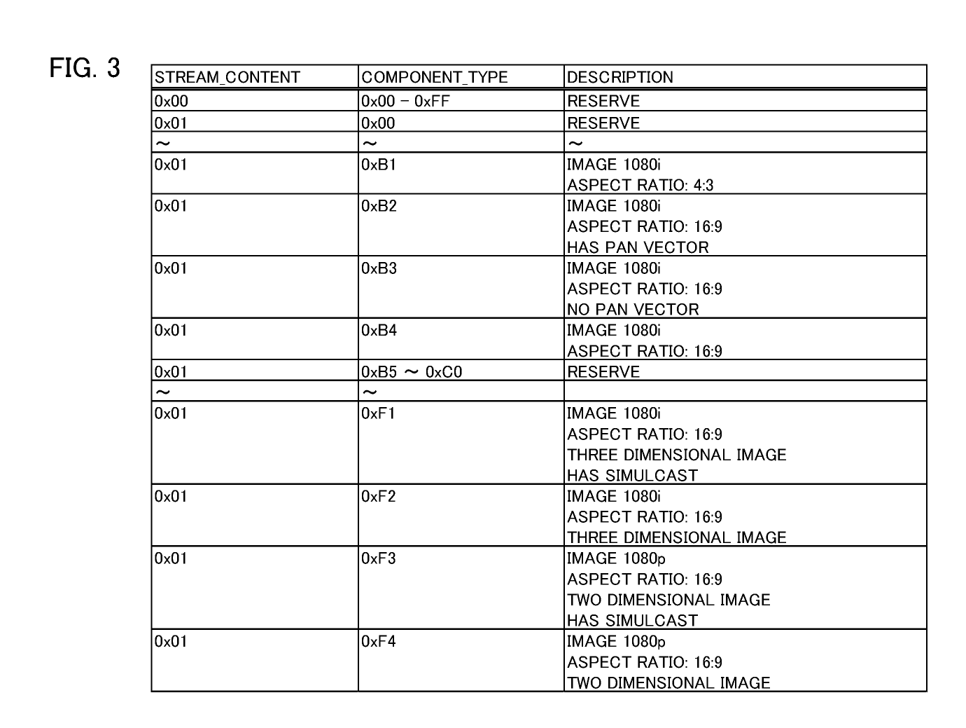

FIG. 3 shows examples of the component descriptors, and the component types 0x00˜0xC0 show the image components that are currently standardized. The examples of descriptions of the image format information (resolution, aspect ratio, three dimensional image/two dimensional image), and information that shows the presence or absence of simulcasting are shown in 0xF1˜0xF4.

The image identifying unit 112 identifies whether the image according to the image ES being processed is a three dimensional image or a two dimensional image based on the information about the component type. The simulcast identifying unit 111 identifies that the image ES being processed is one image stream that belongs to the same group when the component type defines the presence of a simulcast. Here, the expression “same group” denotes that the above-described simulcast consisting of a two dimensional broadcast program and a three dimensional broadcast program having an identical content are treated as one group. In addition, the simulcast identifying unit 111 can detect the channel of the image ES being processed and the channel related to a simulcast, that is, other channels in the same group. This identification is carried out based on the component descriptor in the IET, the service ID of the link descriptor, the broadcast information, and the network identifying information.

The glasses control and communication unit 113 carries out shutter control of by glasses 114 by synchronizing the timing at which the left eye image and the right eye image are alternately displayed when the displayed image is a three dimensional image. Thereby, the user can attain a stereoscopic view by viewing the left eye image with the left eye and the right eye image with the right eye. The glasses 114 have a state-of-wear detecting unit 115, and the glasses control and communication unit 113 can thereby identify whether the classes 114 are being worn by the user. In this case, a technology similar to that disclosed in Japanese Patent Laid-Open No. H9-9296 may be used. Note that in the present invention, whether or not the user is able to view a three dimensional program by using glasses may be identified rather than detecting whether or not the user is actually wearing glasses. That is, a sensor for detecting whether or not the use is wearing the glasses 114, for example, a proximity sensor or a contact sensor and the like, can be used. Of course, when detecting whether glasses are actually being worn, if the glasses 114 are a type driven by an LCD shutter, the control of the invention of the present application can be carried out by detecting that the power switch that drives the glasses has been turned ON. If the power source switch of the glasses has been turned ON, it can be identified that the user can view a three dimensional image by using the glasses. Note that in the explanation of each of the embodiments below, an explanation is provided in which whether or not the user is wearing glasses is detected by the state-of wear detecting unit.

### First Embodiment

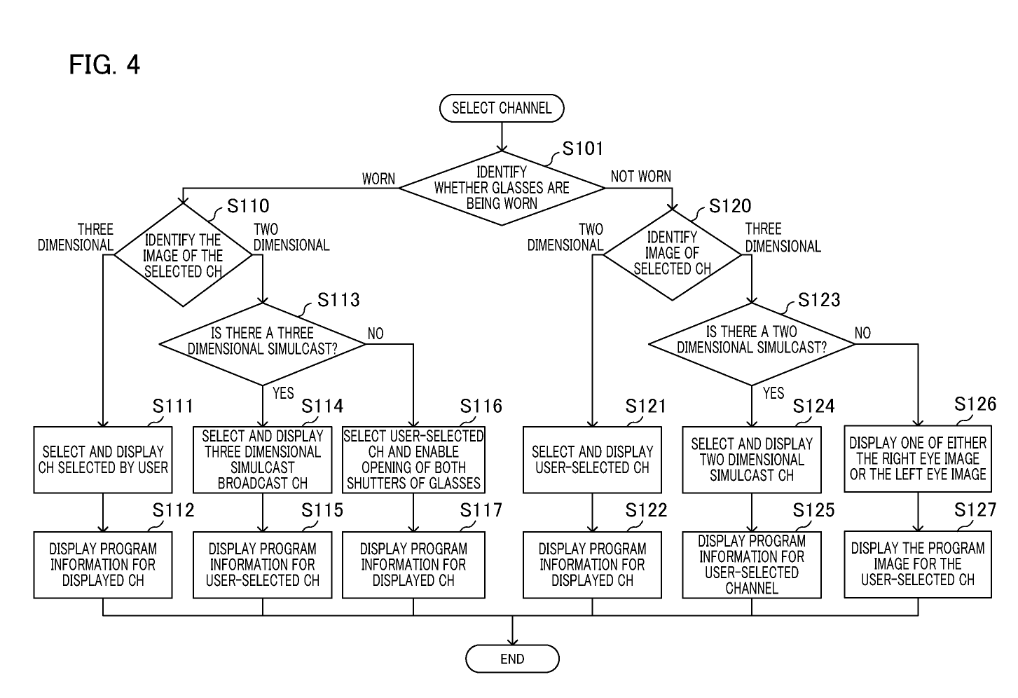

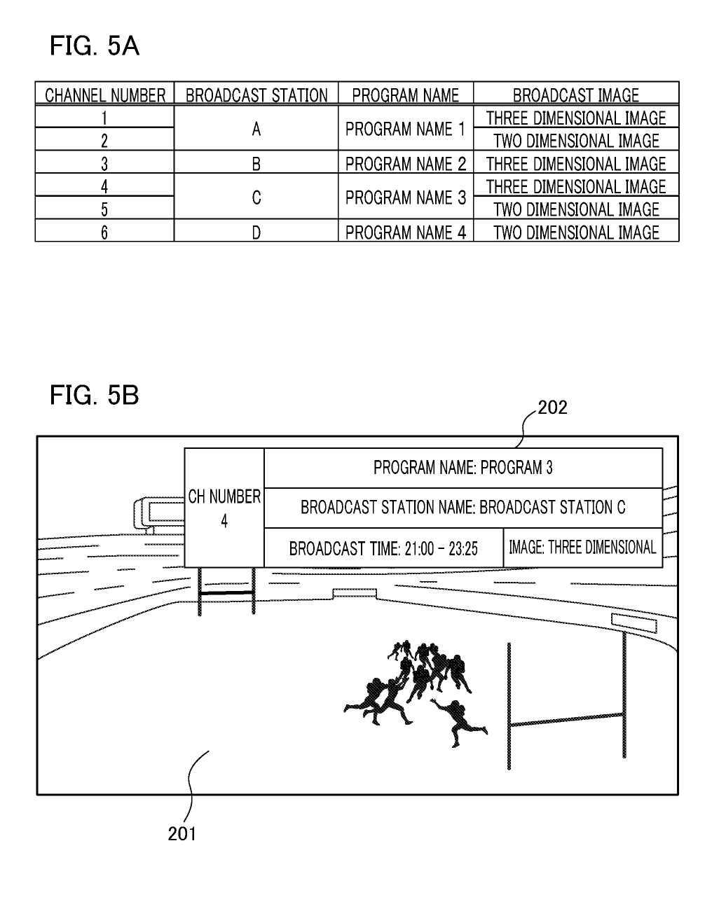

Below, the operation of a first embodiment will be explained with reference to FIG. 4 and FIG. 5.

FIG. 4 is a flowchart that shows an example of channel selection processing, and processing of each of the following steps is carried out according to a program that is interpreted and executed by the CPU of the control unit 125. The processing that is shown in FIG. 4 is started by the user carrying out a channel switching operation by using the remote control.

In S101, the glasses control and communication unit 113 communicates with the glasses 114, and based on the detection signal of the state-of-wear detecting unit 115, identifies whether the user is wearing glasses. As a result, in the case in which it has been identified that the user is wearing the glasses, the processing proceeds to S110, and in the case in which the user is not wearing glasses, the processing proceeds to step 120.

In S110, the image identifying unit 112 identifies whether the image of the program currently being broadcasted on the channel that has been selected by an operation of the user is a three dimensional image or a two dimensional image. This identification can be executed by the image identifying unit 112 by referring to the information about the component type described above. As a result, in the case of a three dimensional image, the processing proceeds to S111, and the selection of the channel the user designated for selection is carried out, and the image of the broadcast program is displayed on the display unit 108. Then the processing proceeds to S112, and the program information display unit 110 displays on a screen the broadcast program information for the program that is displayed on the channel that the user has selected.

In contrast, in S110, in the case in which the image identifying unit 112 has identified a two dimensional image, the processing proceeds to S113. Here, the control unit 125 identifies whether a three dimensional image broadcast, which is a simulcast corresponding to a two dimensional image, is being carried out at this point in time. This identification is equivalent to identifying whether or not a three dimensional program having a content that is identical to that of a program being broadcast on the channel is being broadcast at the point in time that the channel for a two dimensional image has been selected. As a result, in the case in which it is identified that a simulcast is being carried out, the processing proceeds to S114. Here, a channel in the same group, that is, a three dimensional image broadcasting channel of a simulcast, is selected, and the image of the three dimensional image broadcast program being broadcast is displayed on the display unit 108. Specifically, the simulcast identifying unit 111 obtains the component descriptor in the IET, the service ID for the link descriptor, broadcast information, and network identification that has been separated by the TS data processing unit 103. Based on this information, the simulcast identifying unit 111 detects a channel for a three dimensional image broadcast that is in the same group as the two dimensional image broadcast channel that the user has designated for selection. The identified channel is selected and the program is displayed. Then the processing proceeds to S115, and the program information display unit 110 displays broadcast program information on the channel that has been designated for selection, and the processing ends. Therefore, the channel number selected in S114 and the channel number of the broadcast program information displayed in S115 are different. The reason that the broadcast program information for the selected channel is displayed is that there is the possibility that confusion may be caused when a channel number differing from the channel that the user has selected is displayed. Because the user is wearing glasses, the user expects to view a three dimensional image broadcast. Therefore, it is desirable that the image itself display a three dimensional image, and setting the broadcast program information to the broadcast program information for the selected channel is advantageous.

In contrast, in S113, in the case in which it has been identified that a three dimensional image broadcast, which is a simulcast, is not being carried out, that is, in the case in which there is no description of the presence of a simulcast in the component descriptor in the EIT, the processing proceeds to S116. In this case, the channel selected by the user is a two dimensional image broadcast channel, and because there is no corresponding three dimensional image broadcast, an image of a two dimensional is provided to the user wearing the dedicated glasses. Thus, the channel that the user has designated for selection is selected, and the shutter for both eyes in the glasses is always open. Then the processing proceeds to S117, and after the broadcast program information for the displayed channel has been displayed, the processing ends. Note that in the processing of S116, although a two dimensional image is displayed while the user is wearing glasses, unlike the state in which a three dimensional image is viewed while the user is not wearing the glasses, the user does not view an image that is particularly uncomfortable to view. In addition, it is desirable that the user be provided with notification to the effect that a two dimensional image is being displayed.

In S101, in the case in which it has been identified that the user is not wearing glasses, the processing proceeds to S120. Here, the image identifying unit 112, similar to S110, identifies whether the image of the selected channel is a three dimensional image or is a two dimensional image. As a result, in the case in which a two dimensional image has been identified, the processing moves to S121, the channel that the user has designated for selection is selected, and the image of the two dimensional program that is being broadcast is displayed. Then in S122, after the broadcast program information for the program that is displayed on the selected channel has been displayed, the processing ends.

In contrast, in the case in which it is identified that the program image of the channel that was selected in S120 is a three dimensional image, the processing proceeds to S123. In S123, the control unit 125 identifies whether or not a two dimensional image broadcast, which is a simulcast, is being carried out at this point in time. As a result, in the case in which it has been identified that a simulcast is being carried out, the processing moves to S124.

In S124, a channel in the same group, that is, a two dimensional image broadcast channel of the simulcast, is selected, and the image of the two dimensional image broadcast program that is being broadcast is displayed on the display unit 108. Then, in S125, the broadcast program information on the channel that the user has designated for selection is displayed. Therefore, the channel number selected in S125 and the channel number of the broadcast program information displayed in S125 are different.

In addition, in S123, in the case in which it has been identified that a simulcast is not being carried out, the processing proceeds to S126. In S126, because the channel of the three dimensional image broadcast is selected while the user is not wearing glasses and there is no corresponding two dimensional image broadcast, in this case, controls is carried out in which one image among the left eye image and the right eye image is displayed on the display unit 108. Because either among images of the left eye and the right eye is a two dimensional image, if such an image is displayed, the user can view a program similarly to a typical two dimensional image broadcast. Then, in S127, broadcast program information on the channel that has been selected by the user is displayed. In this case, in addition to program information, displaying the supplementary information that a three dimensional image can be viewed if glasses are worn and displaying a three dimensional image as a two dimensional image is advantageous.

Below, a specific example of the operation will be explained below. FIG. 5A exemplifies in a table format the channel numbers, broadcast station names, program names, and the types of the broadcast images. On channel numbers 1 and 2, simulcast of program 1 by broadcast station A is being carried out. On channel number 1, a three dimensional image broadcast is being carried out and on channel number 2, a two dimensional image broadcast is being carried out. In addition, in the same time slot, on channel number 3, a three dimensional image broadcast of program 2 is being carried out by broadcast station B. On channel numbers 4 and 5, simulcasts of program 3 by broadcast station C is being carried out. On channel number 4, a three dimensional image broadcast is being carried out, and on channel number 5, a two dimensional image broadcast is being carried out. On channel number 6, a two dimensional image broadcast of program 4 is being carried out by broadcast station D.

(Scenario 1: Switching from Channel Number 1 to 3 while Wearing Glasses)

Assume that while the broadcasting shown in FIG. 5A is being carried out, the user is wearing the dedicated glasses 114, and the program of channel number 1 is being viewed. In this state, the operation for the case in which the user designates the selection of channel number 3 is explained below. Note that the following selection designation is carried out by pressing the number keys, which are provided on the remote control 121, to which each channel has been assigned.

First, in S101 in FIG. 4, it is identified that the user is wearing glasses, and the processing proceeds to step S110. On the selected channel number 3, because a three dimensional image broadcast is being carried out, the processing proceeds to S111. In addition, the channel that the user has designated for selection, that is, channel number 3, is selected, and the image of program 2 is displayed. In S112, the broadcast program information for the displayed channel 2, that is, the broadcast program information on channel number 3 is displayed as a banner superimposed on the image.

Due to the above operation, while the user is wearing glasses, in the case in which the user has designated the three dimensional image channel for selection, the image of the selected channel and the broadcast program information are displayed, and the user can view the three dimensional image.

(Scenario 2: Switching from Channel Number 2 to 4 while not Wearing Glasses)

Assume that while the broadcast shown in FIG. 5A is being carried out, the user is not wearing glasses and is viewing the broadcast program of channel number 2. In this state, the operation when the user designates for selection channel number 4 will be explained.

First, in S101, it is identified that the user is not wearing glasses, and the processing proceeds to S120. Because a three dimensional image broadcast is being carried out on the selected channel 4, the processing proceeds to S123. Here, it is determined that program 3 on a simulcast two dimensional image broadcast channel is being broadcast, where program 3 in the same group as channel number 4, that is, channel number 5, which is a simulcast of channel number 4. Subsequently, in S124, channel number 5 is selected, and the image of program 3 is displayed. Then in S125, the broadcast program information on the channel that the user has designated for selection, that is, channel number 4, is displayed as a banner. Here, in S124, channel number 5 has been selected, but in S125, caution is necessary because the broadcast program information for channel number 4 is displayed. An example of the screen display at this time is shown in FIG. 5B. In this figure, the image of the screen indicated by reference numeral 201 is a two dimensional image of channel number 5, and the broadcast program information on channel number 4 is displayed in the display area for broadcast program information indicated by reference numeral 202.

Due to the above operation, in the case in which, while not wearing glasses, the user has designated for selection a three dimensional image channel that is a simulcast of a two dimensional image, the two dimensional image of the simulcast is displayed, and at the same time, the broadcast program information of the program that has been designated for selection is displayed. That is, while the user is not wearing glasses, the viewer will not view a three dimensional image, which is uncomfortable to view. In addition, the user can be informed about the presence of a broadcast of a three dimensional image broadcast program corresponding to the program that has been selected by the user from the displayed broadcast program information, and if the glasses are being worn, the user can easily understand that a three dimensional image broadcast can be viewed.

(Scenario 3: Switching from Channel Number 1 to 2 while Glasses are being Worn)

Assume that while the broadcast shown in FIG. 5A is being carried out, the user is wearing glasses and the program on channel number 1 is being viewed. In this state, the operation when the user designates for selection channel number 2 will be explained below.

First, in S101, it is identified that the user is wearing glasses, and the processing proceeds to S110. Here, because it has been determined that the image of the selected channel is a two dimensional image, the processing proceeds to S113. In S113, it is identified that program 1 on channel number 1, which is carrying out a simulcast of the three dimensional image broadcast channel of a simulcast that is the same group, that is, channel number 2, is being broadcast. The processing then proceeds to S114, channel number 1 is selected, and the three dimensional image of program 1 is displayed. However, in this processing, because the channel number has not been changed, essentially channel selection has not been carried out. Then in S115, the broadcast program information on the channel that the user has designated for selection, that is channel number 2, is displayed. Here as well, caution is necessary because in S114, the image of the broadcast program on channel number 1 is displayed, and in S115, the broadcast program information on channel number 2 is displayed.

Due to the above operation, while the user is wearing glasses, in the case in which the user has designated for selection a two dimensional image broadcast channel of a simulcast, a three dimensional image of the simulcast is displayed, and the broadcast program information for the broadcast program that the user has designated for selection is displayed. That is, the user can view a three dimensional image. In addition, the user views the displayed broadcast program information and knows that a two dimensional image broadcast is being broadcast. Thus, the user easily understands that a two dimensional image broadcast can be viewed even when not wearing glasses.

### (Scenario 4: the State of Wearing Glasses Changes)

In the present embodiment, the classes control and communication unit 113 periodically or regularly communicates with the glasses 114, and identifies whether the user is wearing glasses. In the case in which the state of the user wearing the glasses changes, processing is carried out according to the flowchart that is shown in FIG. 4. In this case, the channel that is currently designated for selection is set as the “selected channel”, and the processing shown in FIG. 4 is started.

In scenario 2, assuming the broadcast state of FIG. 5A, in the case in which the user is not wearing glasses and changes the designation of the channel number to be selected from 2 to 4, channel number 5, which is the simulcast broadcast of channel number 4 is selected, and the program information for channel number 4 is displayed. In this state, processing when the user is wearing glasses will be explained below.

The glasses control and communication unit 113 identifies that the state has changed from one in which the user was not wearing glasses to one in which the user is wearing the glasses. Channel number 4 is the channel selection destination, and the flowchart processing shown in FIG. 4 is started. First, because the user is wearing the glasses, the processing proceeds from S101 to S110. In S110, because it has been identified that the image of the program being broadcast on the selected channel is a three dimensional image, the processing moves to S111. The program image of the channel that the user has designated for selection, that is, the program image of channel number 4, is displayed, and in S112, the displayed broadcast program information, that is, the broadcast program information on channel number 4, is displayed.

Due to the above operation, while the user is viewing a two dimensional broadcast program of a simulcast, when the user puts on the glasses, the three dimensional image of the simulcast is automatically selected and displayed, and thus, the user can view a three dimensional image without requiring a special operation.

Note that in the present embodiment, a simulcast is broadcast on a separate channel, but the same broadcast can be realized by providing a plurality of images in three dimensions and two dimensions in one program. In this case, a plurality of image streams on one channel are identified as the same group, and instead of the channel switching described above, an operation and effect identical to that described above can be obtained by carrying out switching of the image stream (ES switching). Specifically, in the case in which the image in a broadcast program for which a switching operation of the displayed image has been carried out while wearing glasses is a two dimensional image, the control unit 125 switches to and displays the three dimensional image in the broadcast program. In addition, in the case in which the image in the broadcast program for which a switching operation has been carried out while not wearing glasses is a three dimensional image, the control unit 125 switches to and displays the two dimensional image in the broadcast program. When displaying an image, the broadcast program information is displayed using the image that has been designated by the switching operation. Thus, in the case in which the user carries out a switching operation of a displayed image while not wearing glasses, displaying an image without distinguishing between a three dimensional image and a two dimensional image does not occur, and the user does not have to view an uncomfortable image.

In addition, after initially identifying that a user is wearing glasses in S101, the glasses control and communication unit 113 identifies the type of the image (two dimensional or three dimensional) in S110 and S120. Although not limiting, a structure may be used in which after carrying out identification processing to identify whether a program image of a channel that has been designated for selection by a user operation is a three dimensional image or a two dimensional image, identification processing of whether glasses are being worn by the user is carried out. That is, after the image identifying unit 112 has identified that a broadcast program of a selected channel is a three dimensional image, the glasses control and communication unit 113 confirms that glasses are being worn, and the display unit 108 displays the program and the broadcast program information of the channel that has been designated for selection by a user operation. In addition, when the glasses control and communication unit 113 has identified that glasses are not being worn, the display unit 108 displays the program of the two dimensional image broadcast channel that is a simulcast and the broadcast program information for the channel that has been designated for selection. In contrast, after the image identifying unit 112 has identified that the program image of the selected channel is a two dimensional image, the glasses control and communication unit 113 confirms that glasses are being worn. The display unit displays the program of the three dimensional image broadcast channel that is a simulcast and the broadcast program information for the channel that has been designated for selection. In addition, when the glasses control and communication unit 113 has identified that glasses are not being worn, the display unit 108 displays the program of the channel designated for selection and the broadcast program information.

According to the embodiment described above, in the case in which a user has designated for selection a channel broadcasting a two dimensional image while wearing glasses, if there is a program of a three dimensional image broadcast corresponding to the program of a two dimensional image broadcast, that three dimensional program is automatically selected and displayed. Thus, the user can view a three dimensional image without carrying out any special operation. In addition, in the case in which the user designates for selection a channel broadcasting a three dimensional image while not wearing glasses, if there is a program of a two dimensional image broadcast corresponding to this program of a three dimensional image broadcast, this two dimensional program is automatically selected and displayed. Thereby, the user can complete the operation without viewing an uncomfortable three dimensional image. Thereby, the convenience to the user can be improved.

Note that in S115 and S125 in FIG. 4 in the embodiment described above, instead of the broadcast program information for the channel broadcasting the image actually being displayed, the broadcast program information for the channel that the user has selected is displayed as a banner. The reason is that confusion may occur when a channel number that is different from the channel that the user has selected is displayed. However, in S115, irrespective of the image type being displayed as “two dimensional” in a broadcast program banner, the actual image is a three dimensional image. Similarly, in S125, irrespective of the image type in the broadcast program banner being displayed as “three dimensional” in the program information banner, the actual image is a two dimensional image. That is, the user may become confused because the image type displayed in a banner differs from the actual image. Thus, in S115 and S125, in addition to a broadcast program banner, displaying a message that provides to the user notification that the image being displayed is a three dimensional (two dimensional) program identical to a program being broadcast on the selected channel is advantageous. Alternatively, in S115 and S125, a broadcast program banner for the displayed channel may be displayed instead of a broadcast program banner for the channel that the user has selected. At this time, because the channel that has been selected by the user is a channel that is broadcasting a two dimensional (three dimensional) image, the display unit 108 displays a message explaining that a different channel that is broadcasting a program having the same content in a three dimensional (two dimensional) image was automatically selected.

In the embodiment described above, a three dimensional image display in a frame sequential format is carried out, and the glasses are a liquid crystal display shutter type. However, as disclosed in the Background of the Invention, the image may be viewed by using glasses in a polarization format. In the deflecting format as well, the content explained in the embodiment described above is substantially identical, but in S116, because there is no concept that polarization format glasses have an open state and a closed state, caution is necessary in that the control at the glasses side is not carried out. The steps other than S116 have processing content that is identical to that for the polarization format.

### Second Embodiment

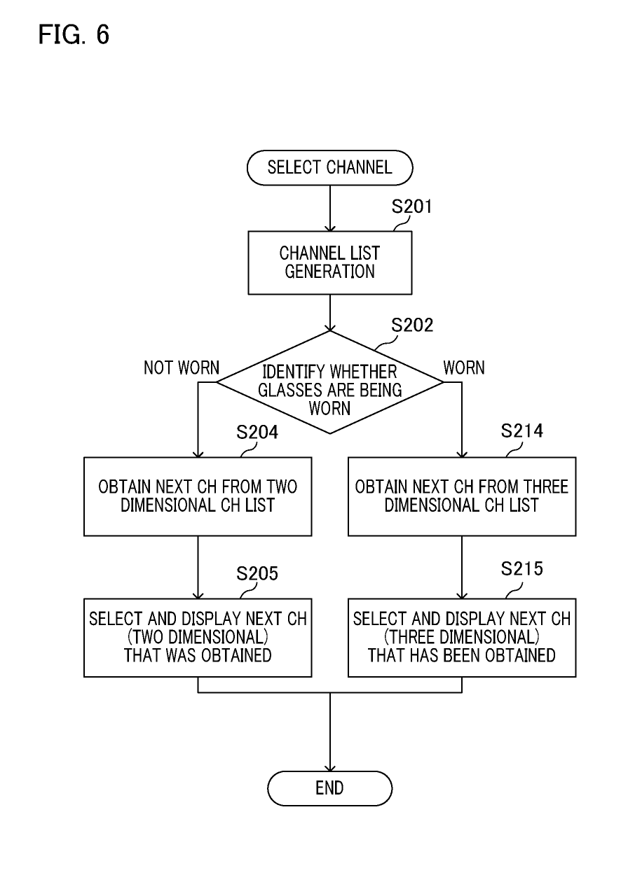

Below, a second embodiment of the present invention will be explained. Note that the configuration of the broadcast receiving apparatus in the second embodiment of the present invention is identical to that of the first embodiment, and thus, the explanation thereof will be omitted. FIG. 6 is a flowchart showing an example of the selection processing in the broadcast receiving apparatus.

The processing that is shown in FIG. 6 is started by a user carrying out a channel switching operation in sequence by an operation of the remote control. Here, “channel switching operation in sequence” denotes an “operation in which the next channel is designated for selection”. The remote control 121 is provided with what is referred to as an up-down selection key that selects the channel number to be selected in an incrementing or decrementing sequence in the order of the channel numbers. By pressing this key, the channel having a channel number above or below the channel that is currently selected can be selected in sequence. For example, in the case in which the channel numbers are arranged in the sequence 101, 102, 103, and 104, while viewing the broadcast on channel number 103, the user can select channel number 104 by carrying out a channel switching operation in the incrementing direction.

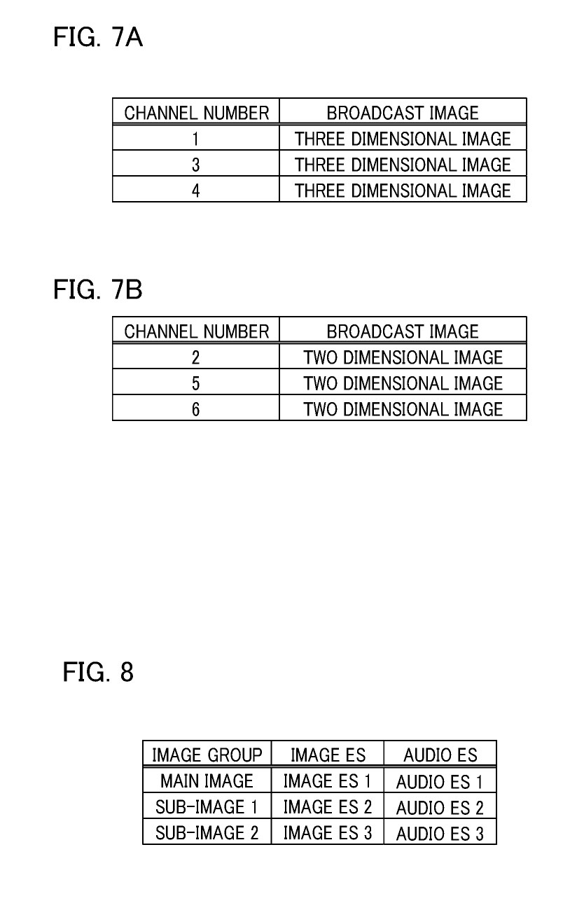

The present embodiment also assumes a broadcast state identical to that in FIG. 5A, and assumes that broadcast stations A to D are carrying out the broadcast of programs 1 to 4 on channel numbers 1 to 6. FIG. 7A illustrates a three dimensional image broadcast channel list (including channel numbers 1, 3, and 4) and FIG. 7B illustrates a two dimensional image broadcast channel list (including channel numbers 2, 5 and 6).

When the user carries out a channel switching operation by using the operation unit that carries out channel selection in sequence, first, in S201 the image identifying unit 112 generates a channel list. This channel list is a list that shows only channels that are carrying out three dimensional image broadcasts or only channels that are carrying out two dimensional image broadcasts. In the state in which the broadcast that is shown in FIG. 5A is being carried out, the three dimensional image broadcast channel list shown in FIG. 7A and the two dimensional image broadcast channel list shown in FIG. 7B are generated. These channel lists are produced by the control unit 125. The control unit 125 detects the component type included in the EIT, and using the identified component type, assigns the broadcasting channels either to the two dimensional image broadcast channel list or the three dimensional image broadcast channel list.

Next, in S202, the glasses control and communication unit 113 communicates with the glasses 114 and identifies whether the user is wearing glasses based on the detection signal of the state-of-wear detecting unit 115. As a result, in the case in which it is identified that the user is wearing glasses, the processing proceeds to S214. In the case in which it has been identified that the user is not wearing glasses, the processing proceeds to S204. In S204, the control unit 125 retrieves and obtains information about the next channel based on the two dimensional image broadcast channel list that is shown in FIG. 7B. Then, in S205, the tuner unit 102 receives a command from the control unit 125, and selects a channel based on the channel information that has been obtained in S204. The image of the program being broadcast on the selected channel is displayed, and the processing sequence described above ends.

For example, assume that while the broadcast shown in FIG. 5A is being carried out, the user is viewing program 3 on channel number 5 without wearing glasses. When the user carries out a channel switching operation in the incrementing direction (the direction in which the channel number increases), channel number 6 is obtained as the next channel number based on the two dimensional image broadcast channel list shown in FIG. 7B. That is, channel 6 is selected, and the two dimensional image of program 4 is displayed. In addition, assume that when the broadcast shown in FIG. 5A is being carried out, the user is viewing the broadcast program 3 on channel number 5 without wearing glasses. When the user carries out a channel switching operation in the decrementing direction (the direction in which the channel number decreases), channel number 2 is obtained as the next channel number based on the two dimensional image broadcast channel list shown in FIG. 7B. That is, channel 2 is selected, and the two dimensional image of program 1 is displayed.

Due to the above operations, in the case in which, while the user is not wearing glasses, an operation is carried out in which a channel selected in an incrementing direction or a decrementing direction is switched in sequence, the channels with three dimensional image broadcasts are skipped, and channels with a two dimensional image broadcasts are automatically selected. Thus, a user not wearing glasses does not have to view uncomfortable three dimensional images.

In contrast, in the case in which, in step S202, it has been identified that the user is wearing glasses, the processing proceeds to S214. In S214, information about the next channel is retrieved from the three dimensional image broadcast channel list shown in FIG. 7A, and processing that obtains the information for the channel is carried out. Then in S215, the tuner unit 102 selects the channel based on the obtained channel information. Subsequently, the image of the program being broadcast on the selected channel is displayed.

For example, assume that while the broadcast shown in FIG. 5A is being carried out, the user is viewing program 2 on channel number 3 wearing glasses. When the user carries out a channel switching operation in the incrementing direction, channel number 4 is obtained as the next channel number based on the three dimensional image broadcast channel list shown in FIG. 7A. That is, channel 4 is selected and the three dimensional image of program 3 is displayed. In addition, assume that while the broadcast shown in FIG. 5A is being carried out, the user is viewing program 2 on channel number 3 while wearing glasses. When the user carries out a channel switching operation in the decrementing direction, channel number 1 is obtained as the next channel number based on the three dimensional image broadcast channel list shown in FIG. 7A. That is, channel 1 is selected, and the three dimensional image of program 1 is displayed.

Due to the above operation, in the case in which the user has carried out an operation in which channels selected in the incrementing direction or the decrementing direction are switched in sequence while the user is wearing glasses, the channels with a two dimensional image broadcast are skipped, and the channels with three dimensional image broadcasts are automatically selected. Thus, the user can view a three dimensional image without requiring a special operation. Thereby, the convenience for the user can be improved. Note an example was explained in which the generation of the channel lists was carried out during the channel switching operation by the user. However, this is not limiting, and a structure may be used in which the channel list is periodically generated during viewing or at a predetermined timing. In addition, channels to be selected can be selected by referring to information for each selection operation or by referring to information such as the EIT, without always requiring the generation of such a channel list. What is important is that in the case in which an operation input is carried out by the user to select in sequence the channels in an incrementing direction or decrementing direction, it is identified whether to select a two dimensional broadcast program or a three dimensional broadcast program depending on whether the user is wearing glasses. The first embodiment described above was characterized by the point that a different channel or image stream having content that is identical to a channel or image stream that the user has designated for selection is selected and displayed. However, the present embodiment selects and displays only a three dimensional image or only a two dimensional image because it is an operation in which the user switches the channels in sequence in an incrementing direction or a decrementing direction.

### Third Embodiment

Below, a third embodiment of the present invention will be explained. Note that the point of difference in structure between the broadcast receiving apparatus according to the third embodiment and the first embodiment is that in the third embodiment, a multi-view broadcast identifying unit 130 is provided, and thus, this point of difference will be explained below.

A “multi-view broadcast” denotes the broadcast of a program in which one program has a plurality of images. The example will be explained using the live broadcast of a baseball game, where the main image is an image centered on the batter, and as sub-images, an image capturing the baseball stadium as a whole and an image capturing the scene at the benches are broadcast in one program. The user can switch and view the desired image among the main image and the sub-images by carrying out a switching operation on the image stream by using a remote control or the like.

A multi-view broadcast program is configured, for example, to multiplex a plurality of image ES and audio ES shown in FIG. 8. In the present example, a main image, a sub-image 1, and a sub-image 2 are shown as an image group. In addition, the main image includes an image ES1 and an audio ES1, the sub-image includes an image ES2 and an audio ES2, and the sub-image 2 includes an image ES3 and an audio ES3.

A multi-view broadcast identifying unit 130 identifies that the program is a multi-new broadcast program when a program being viewed has a plurality of image ESs based on the PIT, and the identified result is transmitted to the control unit 125.

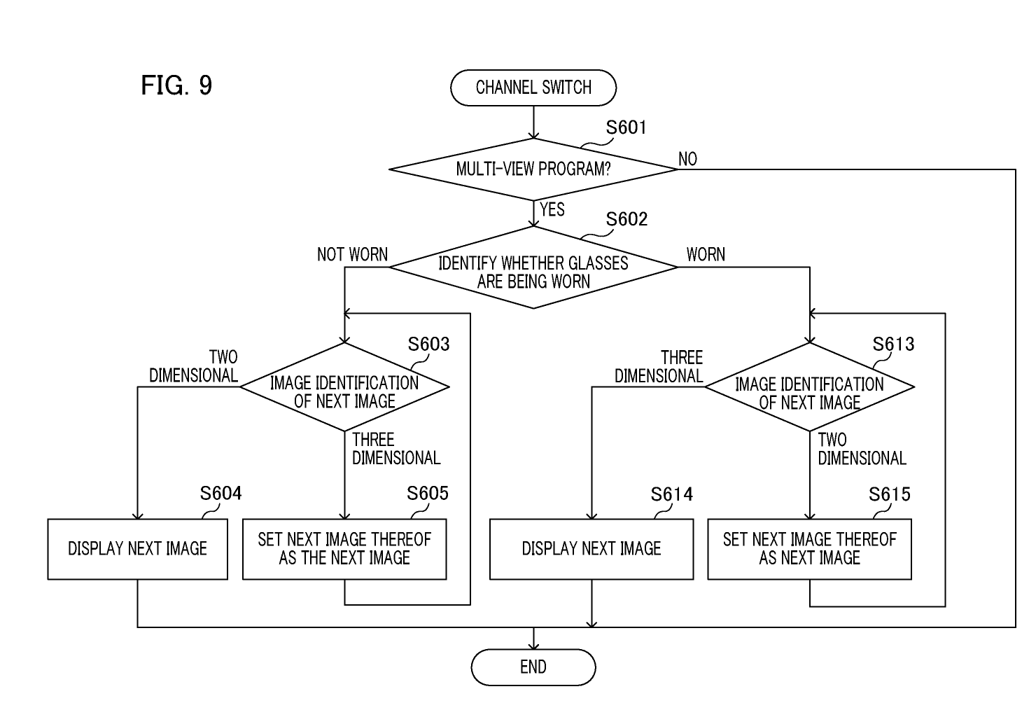

FIG. 9 is a flowchart that shows an example of the image switching process of the broadcast receiving unit. A user starts the process shown in FIG. 9 by carrying out an image switching operation using the remote control 121.

In S601, the multi-view broadcast unit 130 identifies whether or not the program being viewed is a multi-view broadcast program. In the case in which it is a multi-view broadcast program, the processing proceeds to S602, and in the case in which it is not a multi-view broadcast program (NO in S601), the processing is ended because image switching cannot be carried out.

In S602, the glasses control and communication unit 113 communicates with the glasses 114, and identifies whether the user is wearing glasses based on the identification signal of the state-of-wear detecting unit 115. As a result, in the case in which it has been identified that the user is not wearing the glasses 114, the processing proceeds to S603, and in the case in which it is identified that the user is wearing glasses 114, the processing proceeds to S613.

In S603, the image identifying unit 112 extracts the component type from the component descriptors in the EIT that have been separated/isolated by the TS data processing unit 103. Then the image identifying unit 112 identifies whether the next image in the multi-view broadcast program is a three dimensional image or a two dimensional image. As a result, in the case in which the next image is identified to be a two dimensional image, the processing proceeds to S604, and the two dimensional image, that is, the next image in the multi-view broadcast program, is displayed, and the processing ends.

In contrast, in S603, in the case in which the next image is identified to be a three dimensional image, the processing proceeds to S605. As an image ES that is the switching object, another image ES in the multi-view broadcast program is selected and the processing returns to S603. For example, when switching an image from the main image to the sub-image 1, the sub-image 2 is selected as a switched image (the next image), and the processing proceeds to S603.

Due to the above operation, in the case in which the image switching operation is carried out while the user is not wearing glasses, two dimensional images in the multi-view broadcast program are displayed, and thus, the user does not have to view uncomfortable three dimensional images.

In contrast, in S602, in the case in which it has been identified that the user is wearing glasses, the processing proceeds to S613. Here, the image identifying unit 112 extracts the component type from the component descriptor in the EIT that has been separated by the TS data processing unit 103. Then the image identifying unit 112 identifies whether the next image in the multi-view broadcast program is a three dimensional image or a two dimensional image. As a result, in the case in which the next image is identified to be a three dimensional image, the processing proceeds to S614, and this three dimensional image, that is, the next image in the multi-view broadcast program, is displayed, and the processing ends. In S613, in the case in which the next image is identified to be a two dimensional image, the processing proceeds to 615. Here, as an image that is an object of switching, another image ES in the multi-view broadcast program is selected and the processing returns to S613.

Note that an infinite loop occurs in the case in which a two dimensional image is not included in the multi-view broadcast program in the loop process in which the processing returns from S605 to S603 and in the case in which a three dimensional image is not included in the multi-view broadcast program in the loop processing in which the processing returns from S615 to S613. The present example is configured such that after loop processing has been carried out on all images in the multi-view broadcast program, the processing of S605 and S615 is stopped. In the case in which the processing is stopped in order to exit the loop processing, the user is notified about this state by displaying a message to the effect that the image switching has been stopped is displayed because there is no other two dimensional image.

Due to the above operation, in the case in which an image switching operation is carried out while the user is wearing glasses, a three dimensional image of the multi-view broadcast program is displayed, and the user can view a three dimensional without requiring a special operation.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-259417 filed Nov. 13, 2009, and Japanese Patent Application No. 2010-164009 filed Jul. 21, 2010 which are hereby incorporated by reference herein in their entirety.

What is claimed is:

1. A broadcast receiving apparatus that receives a broadcast signal broadcasting three dimensional images that can be stereoscopically viewed by using glasses and two dimensional images that can be viewed without using glasses, comprising
a detecting unit configured to detect whether or not a user can view a three dimensional image by using glasses;
an image identifying unit configured to identify whether the image of the broadcast program on the selected channel is a three dimensional image or a two dimensional image by using identification information that is included in the broadcast signal;
a broadcast identifying unit configured to identify whether or not there is a channel broadcasting a broadcast program having a content identical to that of the broadcast program of the selected channel and a different dimension; and
a control unit configured to control the selection operation according to detected results by the detecting unit, the identification results by the image identifying unit, and the identification results by the broadcast identification unit;
wherein the control unit carries out control so as to select a three dimensional image broadcast channel in the case in which, while a viewer can view a three dimensional image, it is identified that the image of a broadcast program being broadcast on the selected channel is a two dimensional image and it is identified that there is a three dimensional image broadcast channel broadcasting a three dimensional program having a content that is identical to the broadcast program for the two dimensional image, and carries out control so as to select a two dimensional image broadcast channel in the case in which, while a viewer cannot view a three dimensional image, it is identified that the image of a broadcast program being broadcast on a selected channel is a three dimensional image and it is identified that there is a two dimensional image broadcast channel broadcasting a broadcast program of a two dimensional image having a content identical to a broadcast program of a three dimensional image.

2. A broadcast receiving apparatus according to claim 1, further comprising a display control unit configured to carry out control in which the image of a channel that has been selected by the control unit and program information related to a broadcast program are displayed,
wherein, when a user can view a three dimensional image, the display control unit displays an image of a three dimensional image broadcast channel and program information for a broadcast program of a two dimensional image being broadcast on a selected channel in the case in which the image of the broadcast program being broadcast on the selected channel is a two dimensional image and a three dimensional image broadcast channel that is broadcasting a three dimensional program having a content identical to that of the broadcast program of a two dimensional image is selected by the control of the control unit.

3. A broadcast receiving apparatus according to claim 1, further comprising a display control unit configured to carry out control so as to display an image of a channel that has been selected by the control unit along with the program information related to the broadcast program,
wherein, when a user cannot view a three dimensional image, the display control unit displays the image of a two dimensional image broadcast channel and program information for a broadcast program of a three dimensional image being broadcast on the selected channel in the case in which an image of a broadcast program being broadcast on the selected channel is a three dimensional image and the two dimensional image broadcast channel that is broadcasting a broadcast program of a two dimensional image having a content identical to that of the broadcast program of a three dimensional image is selected by the control of the control unit.

4. A broadcast receiving apparatus according to claim 1, further comprising a display control unit configured to carry out control so as to display an image of a channel selected by the control unit and program information related to the broadcast program,
wherein, when the user can view a three dimensional image, the display control unit displays for an image of a three dimensional broadcast channel, program information for a broadcast program of a two dimensional image being broadcast on the three dimensional image broadcast channel, and a message explaining that a three dimensional image broadcast channel has been automatically selected in the case in which the image of the broadcast program being broadcast on the selected channel is a two dimensional image and a three dimensional image broadcast channel that is broadcasting a three dimensional broadcast program having a content that is identical to the broadcast program of the two dimensional image is selected by the control of the control unit.

5. A broadcast receiving apparatus according to claim 1, wherein the detecting unit detects whether or not the user can view a three dimensional image by detecting whether or not the user is wearing the glasses by using a sensor provided on the glasses.

6. A broadcast receiving apparatus according to claim 1, wherein the detecting unit detects that the user can view a three dimensional image by detecting that the power switch provided on the glasses is ON.

7. A broadcast receiving apparatus that receives a broadcast signal broadcasting a three dimensional image that can be viewed by using glasses and a two dimensional image that can be viewed without using the glasses, comprising:
a detecting unit configured to detect whether or not a user can view a three dimensional image using glasses;
a selection unit configured to carry out channel selection in sequence in an incrementing direction or a decrementing direction in the sequence of channel numbers;
an image identifying unit configured to identify whether the image of a broadcast program being broadcast on a selected channel is a three dimensional image or a two dimensional image by using identification information that is included in a signal, and
a control unit configured to control the channel selection operation according to the detected results by the detecting unit and the identified results by the image identification unit,
wherein the control unit carries out control to select channels in sequence by selecting channels broadcasting a three dimensional image in the case in which selection is carried out by the selection unit when the user can view a three dimensional image, and carries out control to select channels in sequence by selecting channels broadcasting a two dimensional image in the case in which channel selection is carried out by the selection unit when the user cannot view a three dimensional image.

8. A broadcast receiving apparatus according to claim 7, wherein
the image identifying unit generates information that shows a set of channels broadcasting a two dimensional image and a set of channels broadcasting a three dimensional image by using the identification information, and
the control unit carries out control in which a channel is selected by using the information that has been generated by the image identifying unit.

9. A broadcast receiving apparatus according to claim 7, wherein the detecting unit detects whether or not a user can view a three dimensional image by detecting whether or not the user is wearing the glasses by using a sensor that is provided on the glasses.

10. A broadcast receiving apparatus according to claim 7, wherein the detecting unit detects whether the user can view a three dimensional image by detecting that a power switch provided on the camera is ON.

11. A control method executed on a broadcast receiving apparatus that receives a broadcast signal broadcasting a three dimensional image that can be stereoscopically viewed by using glasses and a two dimensional image that can be viewed without using the glasses, comprising the steps of:
detecting, in a detecting step, whether or not a user can view a three dimensional image by using glasses;
identifying, in an image identifying step, whether an image of a broadcast program of a selected channel is a three dimensional image or a two dimensional image by using identification information included in the broadcast signal;
identifying, in a broadcast identifying step, whether or not a channel broadcasting a broadcast program having a content that is identical to that of the broadcast program of the selected channel and is a broadcast program having a different dimension is present; and
controlling, in a control step, the selection operation according to the detected result in the detecting step, the identified results in the image identification step, and the identified result in the broadcast identification step,
wherein, in the control step, control is carried out so as to select a three dimensional image broadcast channel in the case in which, while a viewer can view a three dimensional image, it is identified that the image of the broadcast program being broadcast on the selected channel is a two dimensional image and it is identified that there is a three dimensional image broadcast channel broadcasting a three dimensional program having a content that is identical to that of the broadcast program for the two dimensional image, and control is carried out so as to select a two dimensional image broadcast channel in the case in which, while a viewer cannot view a three dimensional image, it is identified that the image of a broadcast program being broadcast on a selected channel is a three dimensional image and it is identified that there is a two dimensional image broadcast channel broadcasting a broadcast program of a two dimensional image having a content that is identical to that of a broadcast program of a three dimensional image.

12. A control method for a broadcast receiving apparatus according to claim 11, further comprising the step of:
carrying out, in a display control step, control so as to display an image of a channel selected by the control step and program information related to the broadcast program,
wherein in the display control step, when a user can view a three dimensional image, the image of a three dimensional image broadcast channel and program information for a broadcast program of a two dimensional image being broadcast on a selected channel are displayed in the case in which the image of the broadcast program being broadcast on the selected channel is a two dimensional image and the three dimensional image broadcast channel that is broadcasting a three dimensional program having a content that is identical to that of the broadcast program of a two dimensional image is selected in the control step.

13. A control method for a broadcast receiving apparatus according to claim 11, further comprising the step of:
carrying out, in a display control step, control in which an image of a channel selected by the control step and program information related to the broadcast program are displayed,
wherein in the display control step, when a user cannot view a three dimensional image, the image of a two dimensional image broadcast channel and program information for a broadcast program of a three dimensional image being broadcast on a selected channel are displayed in the case in which the image of the broadcast program being broadcast on the selected channel is a three dimensional image and the two dimensional image broadcast channel that is broadcasting a broadcast program of a two dimensional image having a content that is identical to that of the broadcast program of the three dimensional image is selected by the control step.

14. A control method for a broadcast receiving apparatus according to claim 11, further comprising the step of:
carrying out, in a display control step, control in which an image of a channel that has been selected by a control step and program information related to the broadcast program are displayed,
wherein, in the display control step, when the user can view a three dimensional image, an image of a three dimensional broadcast channel, program information for a broadcast program of a two dimensional image being broadcast on the three dimensional image broadcast channel, and a message explaining that the three dimensional image broadcast channel has been automatically selected are displayed in the case in which the image of the broadcast program being broadcast on the selected channel is a two dimensional image and the a three dimensional image broadcast channel that is broadcasting a three dimensional broadcast program that has a content that is identical to that of the broadcast program of the two dimensional image is selected by the control of the control step.

15. A control method for a broadcast receiving apparatus according to claim 11, wherein the detecting step detects whether or not a user can view a three dimensional image by detecting whether or not the user is wearing the glasses by using a sensor that is provided on the glasses.

16. A control method for a broadcast receiving apparatus according to claim 11, wherein the detecting step detects that the user can view a three dimensional image by detecting that a power switch provided on the glasses is turned ON.

17. A control method executed by a broadcast receiving apparatus receiving a broadcast signal broadcasting a three dimensional image that can be stereoscopically viewed by using glasses and a two dimensional image that can be viewed without using the glasses, comprising the steps of:
detecting, in a detecting step, whether or not a user can view a three dimensional image by using glasses;
selecting, in a channel selection step, a channel sequentially in an incrementing direction or a decrementing direction in the sequence of the channel numbers;
identifying, in an image identifying step, whether an image of a broadcast program being broadcast on a selected channel is a three dimensional image or a two dimensional image by using identification information included in a signal; and
controlling, in a control step, a selection operation according to the detection results of the detecting step and the identification results of the image identification step;
wherein, in the control step, control is carried out to select channels in sequence by selecting channels broadcasting a three dimensional image in the case in which channel selection has been carried out by the selection step when the user can view a three dimensional image, and control is carried out to select channels in sequence by selecting channels broadcasting a two dimensional image in the case in which channel selection is carried out by the selecting step when the user cannot view a three dimensional image.

18. A control method for a broadcast receiving apparatus according to claim 17, wherein
the image identifying step generates information that displays a set of channels broadcasting a two dimensional image and a set of channels broadcasting a three dimensional image by using the identification information; and
the control step carries out control to select a channel by using the information that has been generated in the image identification step.

19. A control method for a broadcast receiving apparatus according to claim 17, wherein the detecting step detects whether a user can view a three dimensional image by detecting whether or not the user is wearing glasses by using a sensor that is provided in the glasses.

20. A control method for a broadcast receiving apparatus according to claim 17, wherein the detecting step detects whether the user can view a three dimensional image by detecting that a power switch provided on the glasses is ON.
